(19) United States
(12) Patent Application Publication
(10) Pub. No.: US 2007/0081813 A1
(43) Pub. Date: Apr. 12, 2007

(54) Method, medium, and system classifying photos

(75) Inventors: Young-jin Hong, Suwon-si (KR); Seong-woon Kim, Yongin-si (KR); Myung-hyun Yoo, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/509,610

(22) Filed: Aug. 25, 2006

(30) Foreign Application Priority Data
Oct. 10, 2005 (KR) 10-2005-0095084

(51) Int. Cl. G03B 17/24

(52) U.S. Cl. 396/310

(57) ABSTRACT

A method, medium, and system for classifying photos. The system apparatus may include a storage module which stores a plurality of photos, a location-based classification module which classifies the plurality of photos into one or more photo groups according to photographing locations of the plurality of photos, and a time-based classification module which chooses one of the photo groups produced by the location-based classification module and classifies a plurality of photos included in the chosen photo group into one or more sub-photo groups according to photographing times of the photos included in the chosen photo group.

### CROSS-REFERENCE TO RELATED APPLICATIONS

This application claims priority from Korean Patent Application No. 10-2005-0095084 filed on Oct. 10, 2005, in the Korean Intellectual Property Office, the disclosure of which is incorporated herein by reference in its entirety.

### BACKGROUND OF THE INVENTION

1. Field of the Invention

Embodiments of the present invention relate to the classification of photos, and more particularly, to a method, medium, and system classifying photos according to when and where the photos are/were respectively taken.

2. Description of the Related Art

With recent developments in image photographing technology and digital image signal processing, digital photographing devices such as digital cameras and digital camcorders have become widespread, and the number of users of such digital photographing devices has rapidly increased.

Digital photographing devices, unlike analog cameras, may have the capability to take hundreds of pictures. Typically, users may then attempt to classify the pictures by event and store the pictures as a digital photo album, or output the pictures online or offline.

However, as the storage capacities of the digital photographing devices have increased, so have the number of pictures, resulting in it becoming more difficult for users to manually classify their pictures by event and manage the results of the classification. Accordingly, methods of automatically classifying photos have been suggested. In such photo classification methods, a plurality of photos are compared with one another in terms of colors, texture, and the shapes and locations of subjects. The photos may then be classified into one or more corresponding photo groups such that a plurality of photos whose similarity exceeds a predefined threshold value may be grouped together.

However, given that users would usually prefer to classify photos simply according to when the photos were taken or by event, it is difficult to search through the results of such a classification and find a desired photo with reference to the properties of the desired photo.

With this in mind, methods of classifying photos according to when the photos were taken have been suggested. In such classification methods, a plurality of photos are classified by date with reference to time information attached to the photos, and the results of the classification are displayed as a photo calendar. In these conventional photo classification methods, however, a plurality of photos which could be classified into different photo groups because, for example, the photos were taken in different places (e.g., some taken at work and others taken at home) may still be classified into the same photo group only because they were taken on the same date. Such a misclassification may be inconvenient for users.

### SUMMARY OF THE INVENTION

An aspect of an embodiment of the present invention includes a method, medium, and system classifying photos by classifying a plurality of photos with reference to both photographing location information and photographing time information.

Additional aspects and/or advantages of the invention will be set forth in part in the description which follows and, in part, will be apparent from the description, or may be learned by practice of the invention.

To achieve the above and/or other advantages, embodiments of the present invention include a method of classifying photos, including classifying a plurality of photos into one or more photo groups according to photographing locations at which corresponding photos are respectively taken, and performing a photo classifying operation for at least one photo group among the one or more photo groups according to photographing times at which photos included in the photo group are respectively taken.

Here, the classifying of the plurality of photos into one or more photo groups according to the corresponding photographing locations may include creating a grid map having a plurality of cells and mapping to respective cells a quantity of iterations of a photographing operation which have been performed at a location corresponding to the respective cells and user stay time information indicating how long a user has stayed at the location corresponding to the respective cells, wherein each of the respective cells corresponds to one or more pieces of location information, choosing one of the respective cells as a first reference cell, classifying the first reference cell into a first cell group if a quantity of cells which are located within a first predetermined distance of the first reference cell, and correspond to longer user stay times than a first predetermined time, exceeds a first predetermined quantity, and classifying into a first photo group a plurality of photos photographed at locations corresponding to cells that are classified into the first cell group.

The method may further include classifying into a candidate cell group remaining cells of the grid map which do not belong to the first cell group and which correspond to photographing operation iteration quantities not smaller than a value of 1, choosing one of the cells included in the candidate cell group as a second reference cell, classifying the current second reference cell into a second cell group if a quantity of cells which are located within a second predetermined distance of the current second reference cell exceeds a second predetermined quantity, and classifying into a second photo group a plurality of photos corresponding to cells included in the second cell group.

Further, the method may include searching for a name of a place corresponding to photographing location information of the photos included in the second photo group, and mapping the detected place name to the second photo group.

The performing of the photo classifying operation for at least one photo group among the one or more photo groups according to photographing times may include sequentially arranging the photos included in the first photo group in order of photographing times, choosing one of the sequentially arranged photos as a reference photo, and setting a photo group boundary between the reference photo and a next photo after the reference photo if a time interval between the reference photo and the next photo is larger than a sum of a predetermined value and an average of time intervals among a predefined number of photos ahead of or behind the reference photo.

Here, the predetermined value may be determined based on photographing times of the photos included in the second photo group.

The method may further include classifying the current second reference cell into a third cell group if a quantity of cells which are included in the candidate cell group and are located within the second predetermined distance of the current second reference cell is not greater than the second predetermined quantity, and classifying into a third photo group a plurality of photos corresponding to cells included in the third cell group.

To achieve the above and/or other advantages, embodiments of the present invention include a system for classifying photos, including a location-based classification module to classify a plurality of photos into one or more photo groups according to corresponding photographing locations at which the plurality of photos are respectively taken, and a time-based classification module to choose at least one of the photo groups and classify a plurality of photos included in the chosen photo group into one or more sub-photo groups according to photographing times at which the photos included in the chosen photo group are respectively taken.

The system may further include a storage module to store the plurality of photos.

In addition, the system may include an additional information management module to create a grid map having a plurality of cells and to map to respective cells the quantity of iterations of a photographing operation which have been performed at a location corresponding to the respective cells and user stay time information indicating how long a user has stayed at the location corresponding to the respective cells, wherein each of the cells corresponds to one or more pieces of location information, wherein the location-based classification module chooses one of the respective cells as a current first reference cell, classifies the current first reference cell into a first cell group if a quantity of cells which are located within a first predetermined distance of the current first reference cell, and correspond to longer user stay times than a first predetermined time, exceeds a first predetermined quantity, and classifies into a first photo group a plurality of photos corresponding to cells that are classified into the first cell group.

Here, the location-based classification module may classify into a candidate cell group remaining cells of the grid map which do not belong to the first cell group and which correspond to photographing operation iteration quantities not smaller than a value of 1, choose one of the cells included in the candidate cell group as a second reference cell, classify the current second reference cell into a second cell group if a quantity of cells which are located within a second predetermined distance of the current second reference cell exceeds a second predetermined quantity, and classify into a second photo group a plurality of photos corresponding to cells included in the second cell group.

Further, the system may include a group name mapping module to search for a name of a place corresponding to photographing location information of the photos included in the second photo group, and to map the detected place name to the second photo group.

Still further, the time-based classification module may sequentially arrange the photos included in the first photo group in order of photographing times, choose one of the sequentially arranged photos as a reference photo, and set a photo group boundary between the reference photo and a next photo after the reference photo if a time interval between the reference photo and the next photo is larger than a sum of a predetermined value and an average of time intervals among a predefined number of photos ahead of or behind the reference photo.

Here, the predetermined value may be determined based on photographing times of the photos included in the second photo group.

In addition, the location-based classification module may further classify the current second reference cell into a third cell group if a quantity of cells which are included in the candidate cell group and are located within the second predetermined distance of the current second reference cell is not greater than the second predetermined quantity, and classify into a third photo group a plurality of photos corresponding to cells included in the third cell group.

To achieve the above and/or other advantages, embodiments of the present invention include at least one medium including computer readable code to implement an embodiment of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a system for classifying photos, according to an embodiment of the present invention;

FIG. 2 illustrates a table presenting additional information managed by an additional information management module, according to an embodiment of the present invention;

FIG. 3 illustrates a grid map, according to an embodiment of the present invention;

FIG. 4 illustrates a method of storing photos, according to an embodiment of the present invention;

FIG. 5 illustrates a method of classifying photos, according to an embodiment of the present invention;

FIGS. 6A an 6B illustrate a method of classifying photos with reference to photographing location information, according to an embodiment of the present invention;

FIGS. 7A and 7B illustrate a method of classifying photos into a ‘travel’ photo group, according to an embodiment of the present invention;

FIG. 8 illustrates a method of classifying photos with reference to photographing time information, according to an embodiment of the present invention;

FIG. 9 illustrates a plurality of photo groups produced using a method such as the method illustrated in FIG. 8, according to an embodiment of the present invention;

FIG. 10 illustrates a group name mapping method, according to an embodiment of the present invention; and

FIG. 11 illustrates a screen displaying a plurality of photo groups; e.g., obtained using a method of classifying photos, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

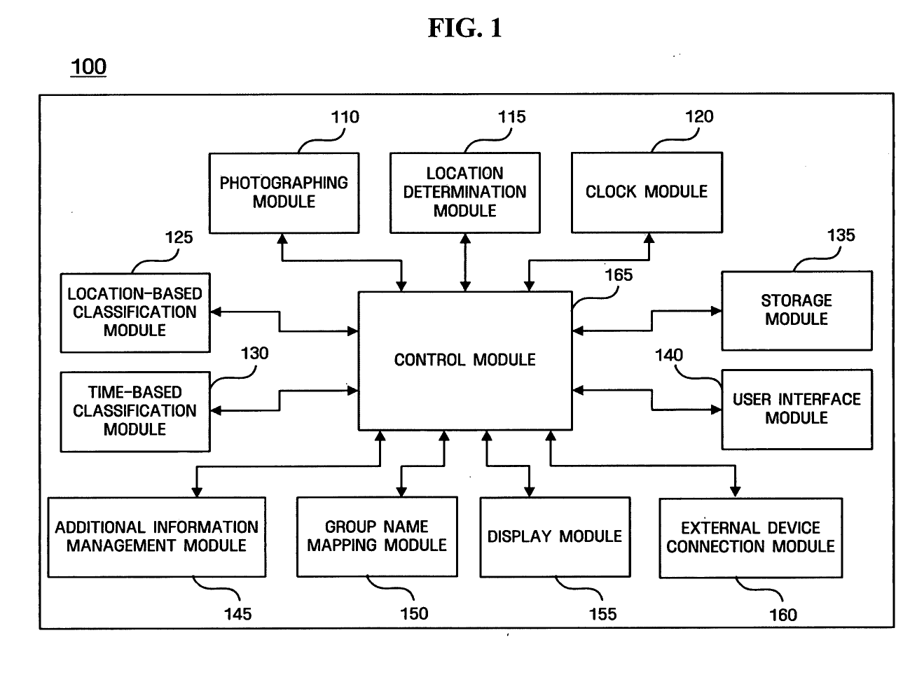

FIG. 1 illustrates system/apparatus 100 classifying photos, according to an embodiment of the present invention. Here, the system/apparatus 100 will be referred to as system 100, though the illustrated elements thereof may also be embodied within a single apparatus, or embodied in separate apparatuses. Referring to FIG. 1, the system 100 may include a photographing module 110, a location determination module 115, a clock module 120, a location-based classification module 125, a time-based classification module 130, a storage module 135, a user interface module 140, an additional information management module 145, a group name mapping module 150, a display module 155, an external device connection module 160, and a control module 165, for example.

The photographing module 110 may perform a photographing operation, and convert a photo obtained by the photographing operation into a digital photo. For this, the photographing module 110 may use typical digital photographing methods which are generally applied to digital cameras, for example.

The location determination module 115 may periodically determine the location of elements of the system 100. The location determination module 115 may determine the location of elements of the system 100 whenever the photographing module 110 performs a photographing operation, for example the location determination module 115 may be embodied with the photographing module 110. The location determined by the location determination module 115 when the photographing module 110 performs a photographing operation will herein be referred to as a photographing location. Photographing location information may be attached to a photo obtained by a corresponding photographing operation, e.g., by the control module 165 when the control module 165 is embodied with the location determination module 115 and photographing module 110, as a tag. The location determination module 115 may determine the location using various methods such as through a cell network, a global positioning system (GPS)-based system, an angle-of-arrival (AOA) method, a time-difference-of-arrival (TDOA) method, and/or an enhanced-observed time difference (E-OTD) method, noting that alternative locating methods may also be available.

The clock module 120 may manage date and time information, for example. In particular, the clock module 120 may manage date and time information indicating when the photographing module 110 determined the location of the photographing module 110 or performs a photographing operation with the photographing module 110. Date and time information indicating when the photographing module 110 performs a photographing operation will hereinafter be referred to as photographing time information. In an embodiment, photographing time information may be attached to a photo, obtained by a corresponding photographing operation, by the control module 165 as a tag, for example. In order to manage date and time information, as an example, the clock module 120 may use time information received from an external device such as a GPS satellite or a communication base station, noting that these are only examples and alternatives are equally available. As an alternative, the clock module 120 may set a date and time with reference to previously set-up time information, for example.

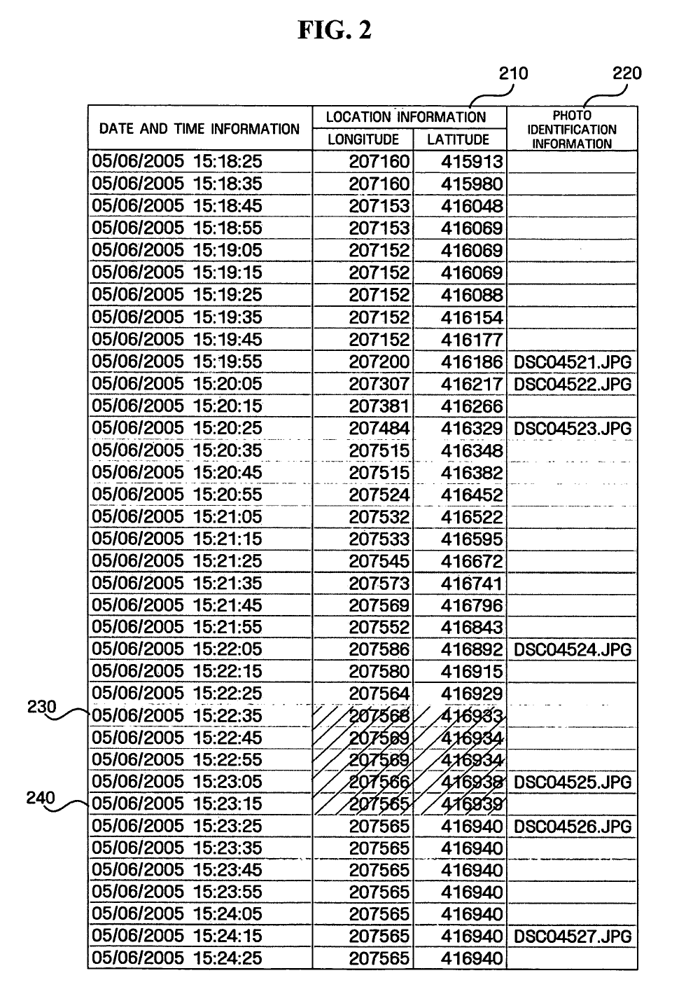

In one embodiment, the additional information management module 145 may manage additional information, such as including location information provided by the location determination module 115, for example, date and time information provided by the clock module 120, for example, and photo identification information of a photo taken by the photographing module 110, for example. Such examples of additional information that could be managed by the additional information management module 145 are presented in a table format in FIG. 2. Referring to FIG. 2, date and time information and location information 210, which may be stored in the table together with photo identification information 220, may respectively be called the photographing time information and photographing location information. The location information 210 may include latitude information and longitude information, for example. The photo identification information 220 may include the file names of photos, for example. Here, these discussions of the specific additional information and/or their specific formats should not be limited to the discussed embodiments, as alternative embodiments are equally available.

The additional information management module 145, for example, may be used to create a grid map using this additional information. The grid map may be made up of N×M cells (where N and M are integers), with each cell being identified by a pair of matrix coordinates. The grid map may be considered a simplified map, for example, with a plurality of pieces of location information being mapped to cells of the grid map. However, the plurality of pieces of location information do not necessarily correspond to the cells of the grid map, respectively. For example, assuming that location information is represented by latitude and longitude coordinates, K (where K is an integer) coordinate points having a particular latitude value and longitude value may be mapped to a single cell of the grid map.

The additional information management module 145, for example, may also map information photographing operation iteration quantity information, e.g., indicating the quantity of iterations of a photographing operation which have been performed at a photographing location to a cell of the grid map corresponding to the photographing location. In addition, the additional information management module 145 could map user stay time information, indicating how long a user has stayed at the photographing location, to the cell of the grid map corresponding to the photographing location. The length of time (hereinafter referred to as user stay time) the user has stayed at a photographing location may be determined based on the additional information, e.g., as managed by the additional information management module 145. For example, assuming that a plurality of locations within the range of a longitude of 207560 to a longitude of 207569 and within the range of a latitude of 416930 to a latitude of 416939 are mapped to an X-th cell of a grid map, and examples of the additional information managed by the additional information management module 145 only include those illustrated in FIG. 2, i.e., date and time information, location information, and photo identification information, user stay time for the X-th cell of the grid map may be determined with reference to a plurality of pieces of date and time information respectively corresponding to a plurality of pieces of location information indicated by hatched lines shown in the table in FIG. 2, and more particularly, date and time information 230 and date and time information 240. In detail, the user stay time for the X-th cell of the grid map may be determined to be equal to a difference of 45 sec, for example, between the date and time information 230 and the date and time information 240. According to an embodiment of the present embodiment, user stay time may be an accumulated amount of time during a predefined time period (e.g., during an hour, a day, a week, or a month) the user spends at a photographing location or an average amount of time the user spends at the photographing location per hour, per day, per week, or per month, for example.

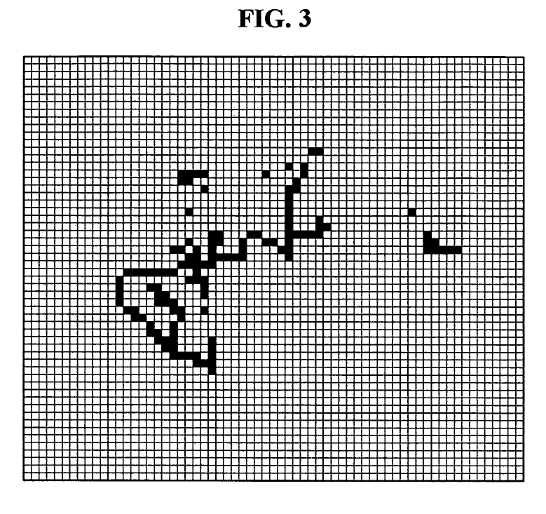

An example of the grid map is illustrated in FIG. 3. Referring to FIG. 3, a plurality of cells are illustrated as darkened cells and may correspond to longer user stay times than a predetermined time and larger photographing operation iteration quantities than a predetermined quantity.

A new grid map may be generated whenever a photo classification request is input by the user, e.g., with the aid of the user interface module 140. However, embodiments of the present invention is are not limited thereto. In an embodiment, the additional information management module 145 may manage a previously generated grid map by updating the grid map whenever a new photo, e.g., taken by the photographing module 110, is stored in the storage module 135 or added by another operation, e.g., if the system performed in a album generation process, or a photo present in the storage module 135 is deleted, for example.

The storage module 135, for example, may store photos taken by the photographing module 110. For this, the storage module 135, or any other utilized storage area, may include a nonvolatile memory such as a flash memory which is writable, readable, and erasable, for example. The storage module 135 may further store digital photos obtained by an analog-to-digital conversion operation. Here, a variety of types of photos may be stored in the storage module 135 as long as they can be recognized by the system 100, for example, noting that embodiments of the present invention are not limited thereto. In one embodiment, photographing location information, e.g., provided by the location determination module 115, and photographing time information, e.g., provided by the clock module 120, may be attached to each of the photos stored in the storage module 135 as tags, for example.

The location-based classification module 125, for example, may classify the photos stored in the storage module 135 according to their photographing locations. According to one embodiment, the location-based classification module 125 may classify the stored photos into a ‘daily’ photo group including a plurality of photos taken in places (hereinafter referred to as daily places) where the user normally performs daily activities and into a ‘travel’ photo group including a plurality of photos taken in places (hereinafter referred to as travel places) where the user has traveled. Here, it is noted that these are just example, and alternative classifiers are equally available. For this, as an example, the location-based classification module 125 may classify the stored photos in one or more photo groups such that a plurality of photos whose photographing locations are within a predetermined distance of a reference location belong to the same photo group. In one embodiment, the location-based classification module 125 may classify the stored photos using the grid map managed by the additional information management module 145, for example.

In detail, and as an example, location-based classification module 125 may arbitrarily choose one of the cells of the grid map as a reference cell, and determine the quantity of cells that are located within a predetermined distance of the chosen cell and which correspond to longer user stay times than a predetermined time. If the determined cell quantity is greater than a predetermined cell quantity, the location-based classification module 125 may determine the corresponding place of that chosen cell to be a daily place. Accordingly, in this embodiment, the location-based classification module 125 may classify the chosen cell into a ‘daily’ cell group. The location-based classification module 125 may perform the aforementioned operation on the other cells of the grid map and may further classify into a ‘daily’ photo group a plurality of photos that correspond to a plurality of cells included in the ‘daily’ cell group.

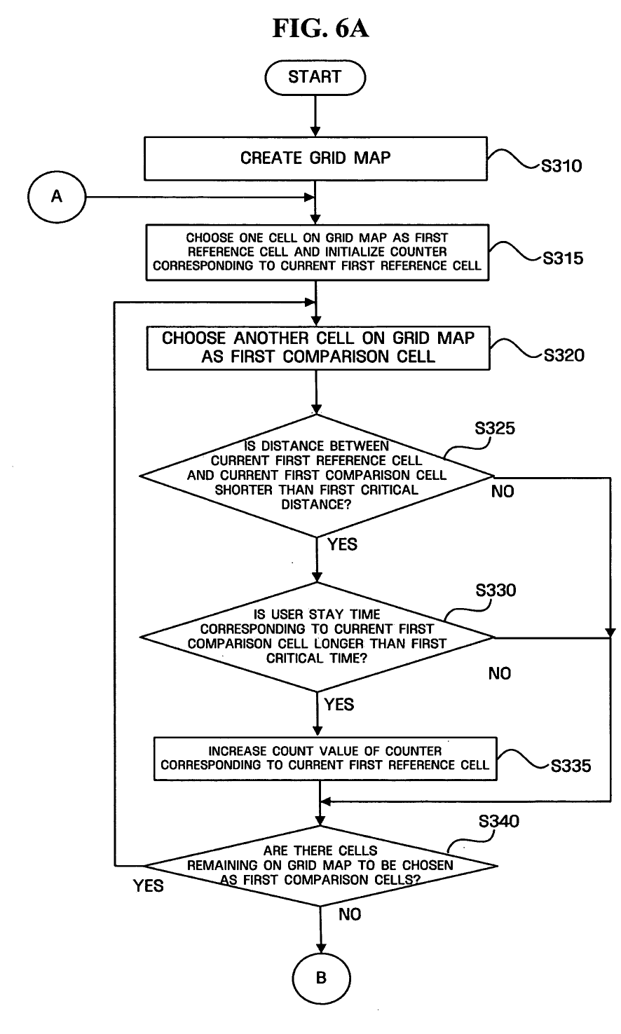

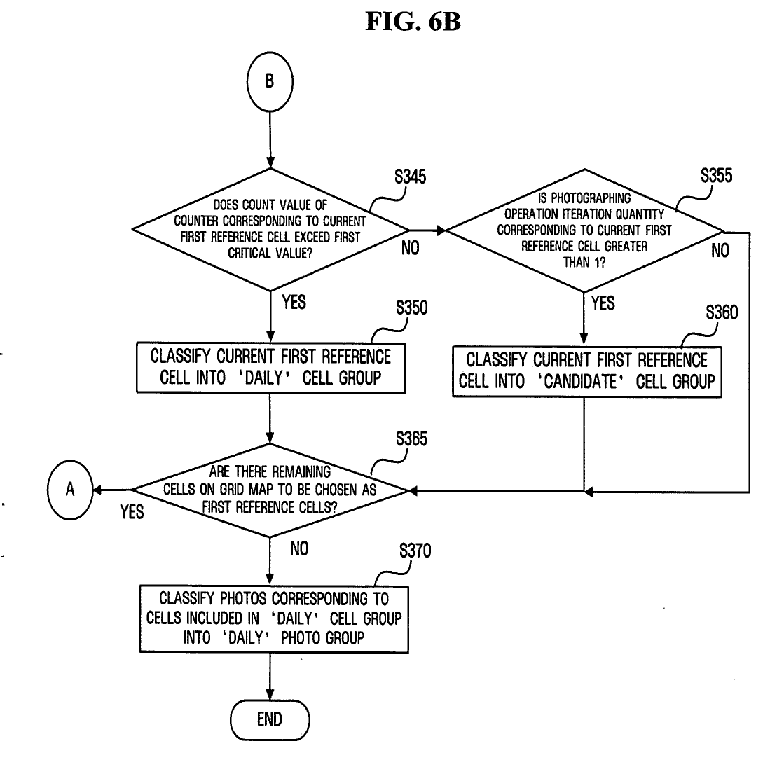

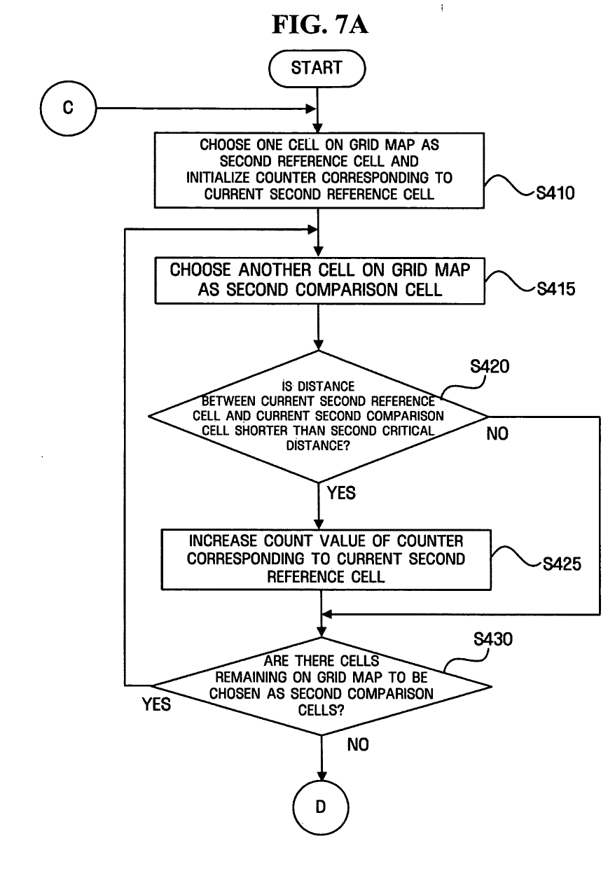

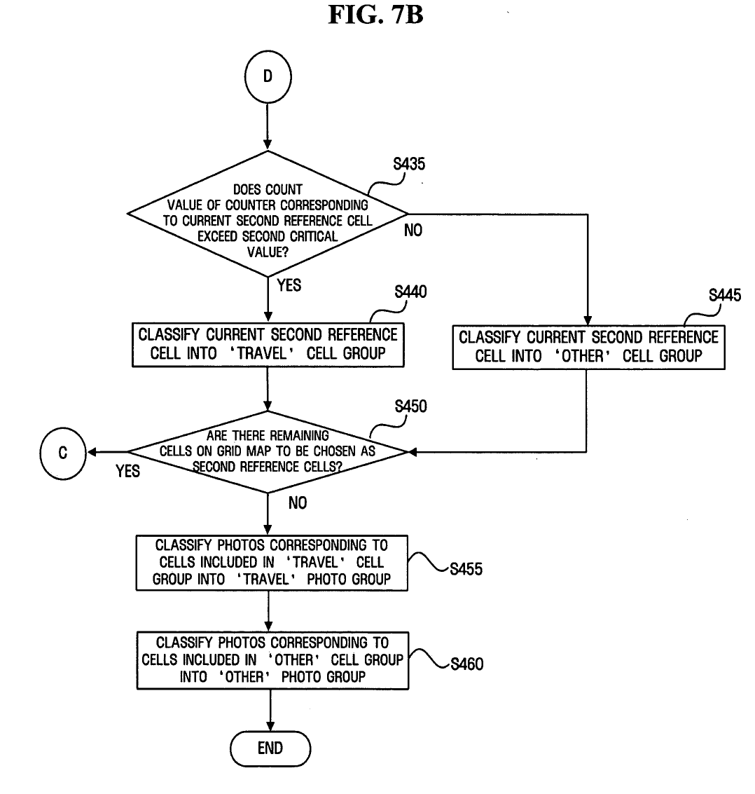

In such an embodiment, the location-based classification module 125 may classify the remaining cells of the grid map not belonging to the ‘daily’ cell group into a ‘candidate’ cell group, and perform an operation similar to the aforementioned operation on the cells included in the ‘candidate’ cell group. Thereafter, the location-based classification module 125 may classify only the cells which are included in the ‘candidate’ cell group and satisfy predetermined conditions into a ‘travel’ cell group, and classify into a ‘travel’ photo group a plurality of photos that correspond to the cells included in the ‘travel’ cell group. A classification operation performable by the location-based classification module 125, for example, will be described further below in more detail with reference to FIGS. 6-7B.

The time-based classification module 130 may choose one of the photo groups, e.g., produced by the location-based classification module 125, and classify a plurality of photos included in the chosen photo group into one or more sub-photo groups, e.g., according to when the photos were taken. For this, the time-based classification module 130, for example, may use a variety of conventional time-based photo classification methods, for example, a photo classification method has been discussed in U.S. patent application Ser. No. 2003-009469, where a plurality of photos are sequentially arranged in order of photographing times. Here, if an N-th photo and an (N+1)-th photo have a time interval of gN and the time interval gN is larger than an average of time intervals among a predefined quantity of photos ahead of or behind the N-th photo, the N-th photo and the (N+1)-th photo are determined to belong to different photo groups with the photo group boundary interposed between the N-th photo and the (N+1)-th photo, as indicated by the below Equation 1.

Equation 1:

$$log ( {g}_{N} ) \geq K + \frac{1}{2 d + 1} {\sum }_{i = - d}^{d} log ( {g}_{N + i} )$$

Here, d represents the predefined photo quantity used to produce the average time interval, and K is a predetermined value used to set photo group boundaries and can be determined experimentally or automatically according to a photographing pattern chosen by a user. Further, here in this discussed method, the predetermined value K may be log(17). The predetermined value K considerably affects how much a plurality of photo groups produced by a photo classification operation coincide with respective corresponding events recognized by the user.

Therefore, according to an embodiment of the present embodiment, the predetermined value K may be automatically determined according to a photographing pattern chosen by the user, instead of setting the predetermined value K by default. According to a further embodiment, the time-based classification module 130 may use photographing time information of a plurality of photos included in the ‘travel’ photo group produced by the location-based classification module 125 to determine the predetermined value K, and use the determined predetermined value K to classify a plurality of photos included in the ‘daily’ photo group produced by the location-based classification module 125 into one or more sub-photo groups.

The group name mapping module 150, for example, may respectively map a plurality of group names to a plurality of photo groups. For example, if the photos included in the ‘daily’ photo group, e.g., produced by the location-based classification module 125, are classified into one or more sub-photo groups according to their photographing times, e.g., by the time-based classification module 130, the group name mapping module 150 may respectively map a plurality of photographing dates to the sub-photo groups as the names of the sub-photo groups, for example. As an alternative, the group name mapping module 150 may map the name of a representative place among the travel places to the ‘travel’ photo group as the name of the ‘travel’ photo group, noting that additional alternatives are also available. If the ‘travel’ photo group includes a plurality of photos taken in different travel places, the group name mapping module 150 may map the names of the different travel places to the respective photos. In this embodiment, the control module 165 may group a plurality of photos to which the same place name is mapped by the group name mapping module 150.

The group name mapping module 150 may search for the name of a place corresponding to a predetermined photographing location, e.g., with reference to a map database which stores a plurality of pieces of location information and the names of places respectively corresponding to the plurality of pieces of location information. For this, the map database may be stored in the storage module 135, for example. Alternatively, the map database may be stored in an additional storage module (not shown) of the system 100 or a portable storage medium, for example, which could be connected to the system 100 via the external device connection module 160. Here, it is briefly noted that the elements of the system 100 may all be embodied in a single apparatus, or in separate apparatuses.

The user interface module 140 may receive a photo classification request from the user, for example. For this embodiment, the user interface module 140 may include an input unit such as a keypad or a touch screen.

The display module 155 may display the photo groups, e.g., as produced by the location-based classification module 125 and the time-based classification module 130, for example. In on embodiment, the display module 155 may be realized as a liquid crystal display (LCD) device, a plasma display panel (PDP) device, or an organic electroluminescence (EL) device, for example, noting that alternative embodiments are equally available.

In another embodiment, the external device connection module 160 may connected to an external device such as a printer, a portable storage medium (e.g., a USB storage or an SD card), or a computer, for example, and then transmit photos stored in the storage module 135 to the external device or receive data from the external device.

In still another embodiment, the control module 165 may control operations of the photographing module 110, the location determination module 115, the clock module 120, the location-based classification module 125, the time-based classification module 130, the storage module 135, the user interface module 140, the additional information management module 145, the group name mapping module 150, and the display module 155, for example.

According to an embodiment of the present embodiment, the system 100 may be realized as a device such as a digital camera or a digital camcorder, which may have both a photographing function and a storage function. However, embodiments of the present invention are not limited thereto, as noted above. For example, the system 100 could also be part of a cell phone or a PDA equipped with a digital camera, or part of a distributed system.

In addition, the term ‘module’, as used herein, may mean, but is not limited to, software and/or hardware components, such as a Field Programmable Gate Array(FPGA) and/or Application Specific Integrated Circuit (ASIC). Thus, a module may include, by way of only examples, components, such as software components, object-oriented software components, class components and task components, processes, functions, attributes, procedures, subroutines, segments of program code, drivers, firmware, microcode, circuitry, data, databases, data structures, tables, arrays, and variables, etc. The functionality provided for in the components and modules may be combined into fewer components and modules or further separated into additional components and modules. Herein, the reference to a ‘system’ refers to at least to the above, but still should not be limited to the same.

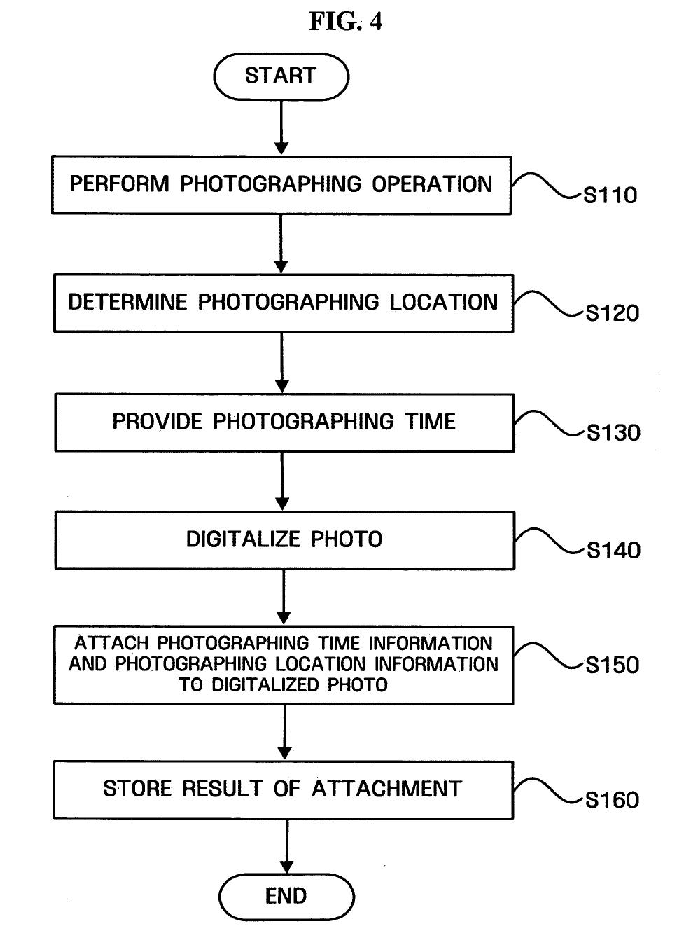

According to further embodiments of the present invention, FIG. 4 illustrates a method of storing photos. Referring to FIG. 4, in operation S110, a photo may be taken. Some time thereafter, or coincident therewith, for example, a current location for the photo and photographing time information indicating the time when the photo was taken may be determined, in operations S120 and S130, respectively.

The photo may be digitalized, in operation S140, and the photographing location information and the photographing time information may be attached to the digitalized photo as tags, for example, in operation S150.

In operation S160, the photo with the attachment may then be stored, for example.

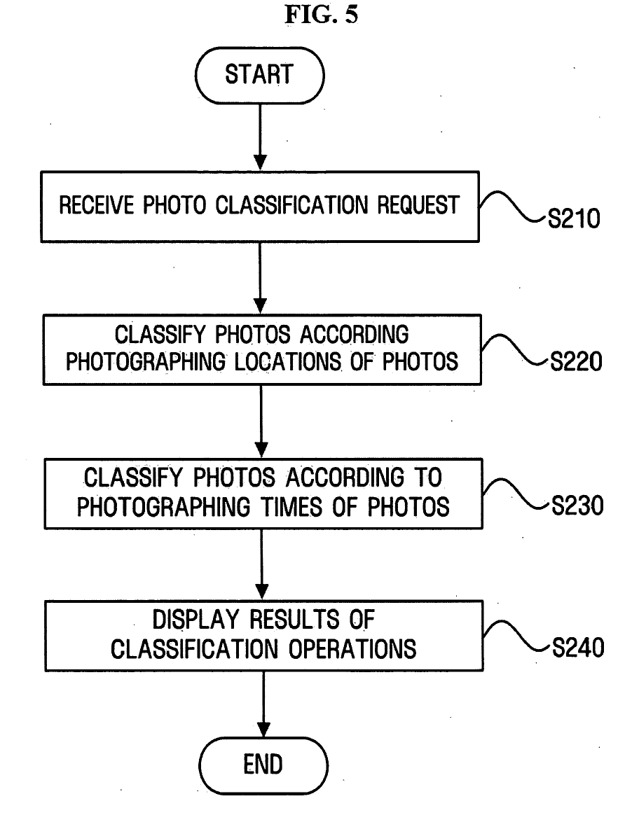

FIG. 5 illustrates a method of classifying photos, according to an embodiment of the present invention. Referring to FIG. 5, a plurality of photos may be stored, e.g., by repeatedly performing the aforementioned operations in FIG. 4. Further, in operation S210, a photo classification request issued by a user could be input, e.g., via the aforementioned user interface module 140, and then, according to one embodiment of the present invention, the stored photos may be classified into one or more photo groups according to their photographing locations, in operation S220. Here, it is not necessary for user interoperation, as such operations could be performed automatically, for example. According to an embodiment, this operation S220 may further be performed using a grid map, as will be described in greater detail below with reference to FIGS. 6A-6B and 7A and 7B.

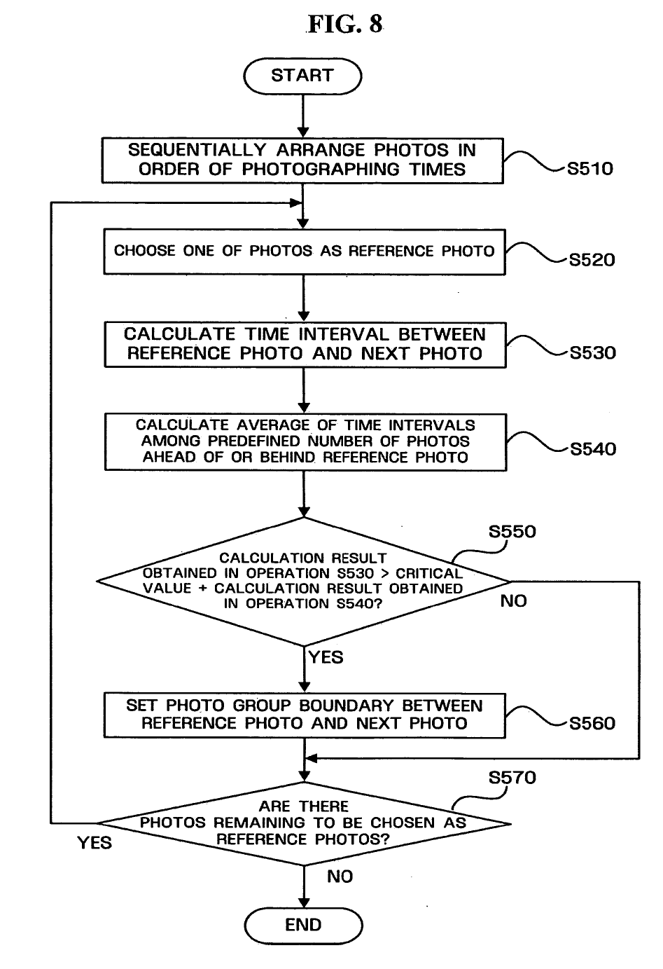

operation S230, at least one of the photo groups, e.g., as produced by the location-based classification module 125, may be chosen and a time-based classification operation on the chosen photo group may further be performed according to the photographing times of a plurality of photos included in the chosen photo group, for example. Here, operation S230 may also be performed using a predetermined algorithm, as indicated by the Equation 1. In such a case, the predetermined value K may be automatically determined according to a photographing pattern chosen by the user, for example, which will be described in greater detail below with reference to FIG. 8.

In operation S240, such resultant photo groups may be displayed.

FIGS. 6A and 6B illustrate a method of classifying photos with reference to photographing location information of the photos, according to an embodiment of the present invention. Referring to the method of FIGS. 6A and 6B, in operation S310, a grid map may be created, such as by the additional information management module 145. The grid map may include a plurality of cells respectively corresponding to a plurality of pieces of location, e.g., with photographing operation iteration quantity information and user stay time information being mapped to each of the cells of the grid map.

One of the cells of the grid map may arbitrarily be chosen as a first reference cell, and a count value of a counter corresponding to the current first reference cell may be initialized to, for example, 0, in operation S315.

Another of the cells of the grid map may be chosen as a first comparison cell, in operation S320.

Whether the distance between the current first reference cell and the current first comparison cell is longer than a first predetermined distance may then be determined, in operation S325.

Thereafter, if the distance between the current first reference cell and the current first comparison cell is not longer than the first predetermined distance, whether a user stay time corresponding to the current first comparison cell is longer than a first predetermined time may then be determined, in operation S330.

In addition, if the user stay time corresponding to the current first comparison cell is not longer than the first predetermined time, a count value of a counter corresponding to the current first comparison cell may be increased by a predetermined amount, in operation S335. Here, the counter corresponding to the current first comparison cell may be an integer value and the predetermined amount may be 1, for example.

In operation S340, whether there are cells remaining on the grid map to be chosen as comparison cells may further be determined, in operation S340. Here, if the distance between the current first reference cell and the current first comparison cell is longer than the first predetermined distance or if the user stay time corresponding to the current first comparison cell is not longer than the first predetermined time, the method may directly proceed to operation S340.

If there are unchosen cells remaining on the grid map, operations S320 through S335 may be repeatedly performed. However, if none of the cells on the grid map remain unchosen, the whether the count value of the counter corresponding to the current first reference cell is greater than a first predetermined value may be determined. In operation S350, if the count value of the counter corresponding to the current first reference cell exceeds the first predetermined value, the current first reference cell may be classified into a ‘daily’ cell group. In other words, if the quantity of cells which are located within a first predetermined distance of the current first reference cell and correspond to longer user stay times than the first predetermined time is greater than the first predetermined value, the current first reference cell may be classified into the ‘daily’ cell group.

If the count value of the counter corresponding to the current first reference cell does not exceed the first predetermined value, the whether photographing operation iteration quantity corresponding to the current first reference cell is greater than 1 may be determined. Here, in operation S360, if the photographing operation iteration quantity corresponding to the current first reference cell is greater than 1, a place corresponding to the current first reference cell may be determined to likely be a travel place, and the current first reference cell may be classified into a ‘candidate’ cell group.

In operation S365, cells remaining on the grid map to be chosen may be determined to be first reference cells.

If there are unchosen cells still remaining on the grid map, the operations S315 through S360 may be repeatedly performed. However, if none of the cells on the grid map remain unchosen, a plurality of photos, e.g., which may be stored in the storage module 135, may be classified into a ‘daily’ photo group to correspond to a plurality of cells included in the ‘daily’ cell group. Such photos included in the ‘daily’ photo group may include photos taken at home, at school, or at work by the user.

Further, a plurality of cells included in the ‘candidate’ cell group, such as that produced in operation S360, may be classified into one or more sub-cell groups, as will be described in greater detail below.

FIGS. 7A and 7B illustrate a method of classifying photos into a ‘travel’ photo group, according to an embodiment of the present invention. Such a method as that illustrated in

FIGS. 7A and 7B may be performed on a plurality of cells of a grid map which are classified into the ‘candidate’ cell group, e.g., in the above operation S360.

In operation S410, one of the cells included in the ‘candidate’ cell group may be chosen as a second reference cell, and a count value of a counter corresponding to the current second reference cell to may be initialized to, for example, 0.

Another of the cells included in the ‘candidate’ cell group may be further chosen as a first comparison cell, in operation S415.

Whether the distance between the current second reference cell and the current first comparison cell is longer than a second predetermined distance may then be determined, in operation S420. In one embodiment, the second predetermined distance may be the same as the first predetermined distance used in the above operation S325, though embodiments of the present invention are not limited thereto.

If the distance between the current second reference cell and the current first comparison cell is not longer than the second predetermined distance, a count value of a counter corresponding to the current second reference cell may be increased by a predetermined amount, in operation S425. Here, the count value of the counter corresponding to the current second reference cell may be an integer value and the predetermined amount may be 1, for example.

Whether there are cells remaining on the grid map to be chosen as comparison cells may then be determined, in operation S430. Above, if the distance between the current second reference cell and the current first comparison cell is longer than the second predetermined distance, the method may directly proceed to operation S430.

If there are unchosen cells still remaining on the grid map, operations S415 through S425 may be repeatedly performed. However, if none of the cells on the grid map remain unchosen, whether the count value of the counter corresponding to the current second reference cell exceeds a second predetermined value may be determined, in operation S435. Here, similar to above, in one embodiment, the second predetermined value may be the same as the first predetermined value used in the above operation S345, though embodiments of the present invention are not limited thereto.

In operation S440, if the count value of the counter corresponding to the current second reference cell exceeds the second predetermined value, the current second reference cell may be classified into the ‘travel’ cell group. Further, in operation S445, if the count value of the counter corresponding to the current second reference cell does not exceed the second predetermined value, the current second reference cell may be classified into an ‘other’ cell group. In short, if the quantity of cells which are included in the ‘candidate’ cell group and located within a fourth predetermined distance of the current second reference cell exceeds the second predetermined value, the current second reference cell may be classified into the ‘travel’ cell group. Otherwise, the current second reference cell may be classified into the ‘other’ cell group.

Cells remaining on the grid map to be chosen may be determined to be second reference cells, in operation S450.

If there are unchosen cells still remaining on the grid map, operations S410 through S445 may be repeatedly performed. However, if none of the cells on the grid map remain unchosen, a plurality of photos, e.g., which may be stored in the storage module 135, may be classified into a ‘travel’ photo group to correspond to a plurality of cells included in the ‘travel’ cell group, in operation S455.

A plurality of photos, e.g., which may also be stored in the storage module 135, may be classified into an ‘other’ photo group to correspond to a plurality of cells included in the ‘other’ cell group, in operation S460.

Here, operations S445 and S460 may be performed to classify a plurality of photos which are less meaningful to the user, for example, and which may be omitted.

Thus, a plurality of cells included in the ‘daily’ cell group correspond to places frequently visited by the user (e.g., home, school, workplace, and the like), whereas a plurality of cells included in the ‘travel’ cell group correspond to places temporarily and less frequently visited by the user. In this regard, a user stay time is no longer an important factor to determine whether the current first comparison cell corresponds to a travel place. Therefore, the method illustrated in FIGS. 7A and 7B may not include such an operation as operation S330 of the method of FIGS. 6A and 6B, i.e., the determining of whether user stay time corresponding to a cell chosen as a comparison cell is longer than a predetermined time.

FIG. 8 illustrates a method of classifying photos with reference to photographing time information of the photos, according to an embodiment of the present invention, e.g., operation S230 of FIG. 5. Referring to FIG. 8, in operation S510, a plurality of photos which are classified into the ‘daily’ photo group, e.g., by the location-based classification module 125, may be sequentially arranged according to photographing times of the photos, such as by the time-based classification module 130, for example.

One of the photos may be chosen as a reference photo, in operation S520. Further, a time interval between the reference photo and the next photo may be calculated, in operation S530. Time intervals among a predetermined quantity photos ahead of or behind the reference photo may be averaged, in operation S540.

In operation S550, the time interval, e.g., obtained in operation S530, may be compared with the sum of the average time interval, e.g., obtained in operation S540, and a predetermined value, i.e., the aforementioned predetermined value K.

Here, in this embodiment, the predetermined K value may be determined based on the photographing times of the photos included in the ‘travel’ photo group, e.g., by the time-based classification module 130, as indicated by the following Equation 2.

Equation 2:

$$K = \frac{{\sum }_{N = 1}^{C} ( log ( {g}_{N} ) - {\sum }_{i = - d}^{d} log ( {g}_{N + i} ) )}{C ( 2 d + 1 )}$$

Here, C represents the number of photos included in the ‘travel’ photo group, d represents the predetermined photo quantity used to produce the average time interval, e.g., as obtained in operation S540, and gN represents a time interval between an N-th photo and an (N+1)-th photo, such as in the photo arrangement obtained in operation S510.

In operation S560, if the time interval obtained in operation S530 is greater than the sum of the average time interval obtained in operation S540 and the predetermined value K, a photo group boundary may be set between the reference photo and the next photo so that the reference photo and the next photo can be classified into different photo groups.

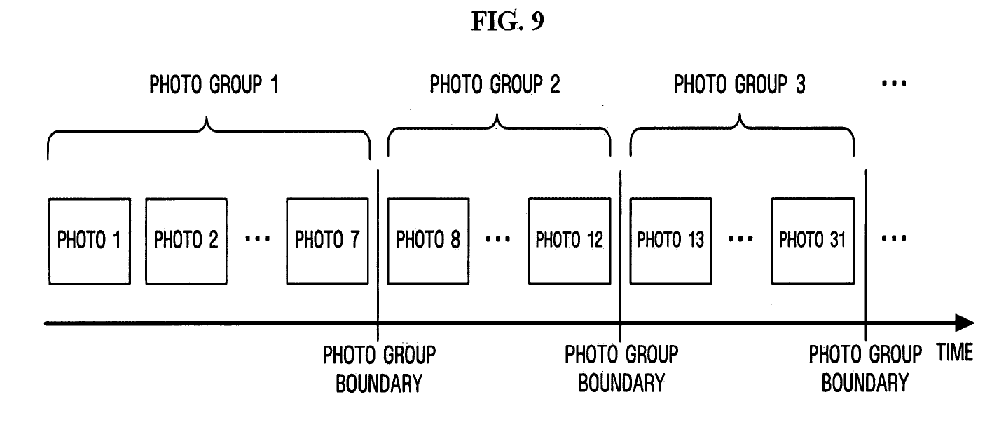

Whether there are photos remaining in the ‘daily’ photo group to be chosen as reference photos may be determined, in operation S570. If there are unchosen photos still remaining in the ‘daily’ photo group, operations S520 through S560 may be repeatedly performed. According to an embodiment, the photos included in the ‘daily’ photo group may be classified into one or more groups according to photographing times of the photos so that a plurality of photos associated with the same event can be grouped together, as illustrated in FIG. 9.

Above, the method illustrated in FIG. 8, according to one embodiment, has been described as being applied to the photos included in the ‘daily’ photo group. However, embodiments of the present invention are not thereto. Thus, the method illustrated in FIG. 8, according to alternate embodiments, may be applied to a plurality of photos included in a photo group other than the ‘daily’ photo group, e.g., a plurality of photos included in the travel group or in the aforementioned ‘other’ photo group. When the method illustrated in FIG. 8 is applied to photos included in the ‘travel’ photo group, the predetermined value K may be a predefined default value, as indicated by Equation 1. Alternatively, the predetermined value K may be determined based on the photos included in the ‘travel’ photo group, as indicated by Equation 2.

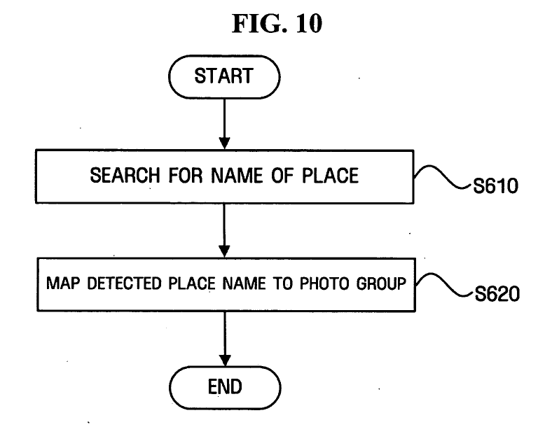

FIG. 10 illustrates a group name mapping method, according to an embodiment of the present invention. Referring to FIG. 10, the group name mapping module 150, for example, may search a predetermined map database for the names of places respectively corresponding to a plurality of pieces of photographing location information of photos which are classified into the ‘travel’ photo group, e.g., by the location-based classification module 125, in operation S610.

The detected place names may be mapped to the respective photos included in the ‘travel’ photo group, in operation S620. Accordingly, the photos included in the ‘travel’ photo group may be classified into one or more sub-photo groups such that a plurality of photos, to which the same place name is mapped, belong to the same sub-photo group.

Referring again to FIG. 5, in operation S240, when a plurality of photos are classified into one or more photo groups such that a plurality of photos, to which the same place name is mapped, belong to the same photo group, the photo groups may be displayed in units of the photo groups, for example. In addition, as an example, the group name mapping module 150 may choose, as representative date information, one of a plurality of pieces of date information of a plurality of photos which are classified into a predetermined photo group, e.g., by the time-based classification module 130, and map the chosen date information to the predetermined photo group as a group name. The chosen date information may be the least recent date information of the plurality of pieces of date information or may be date information corresponding to the median date on which the photos included in the predetermined photo group were taken, for example.

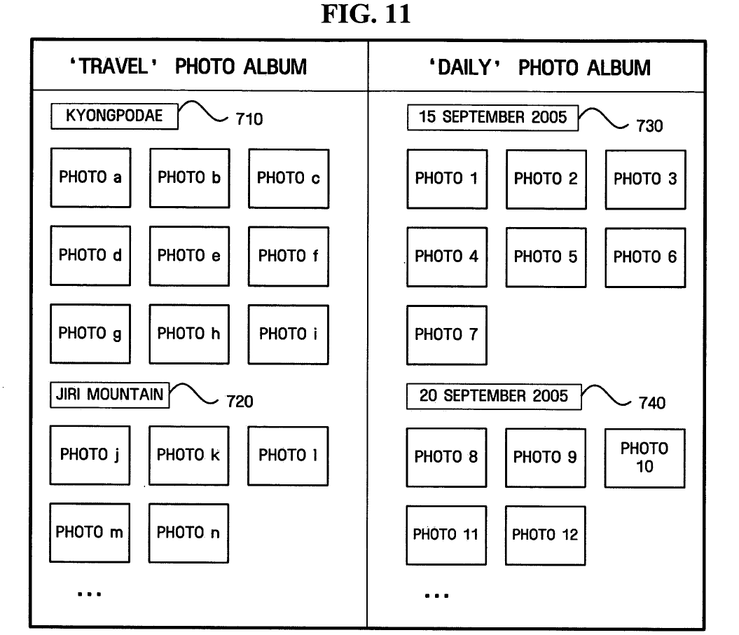

FIG. 11 illustrates a plurality of photo groups which may be displayed by the display module 155, for example, together with respective corresponding group names, e.g., as given by the group name mapping module 150. Referring to FIG. 11, a plurality of photos are classified into a ‘daily’ photo group and a ‘travel’ photo group. A plurality of photos included in the ‘daily’ photo group are classified into a sub-photo group corresponding to a photographing time 730 and a sub-photo group corresponding to a photographing time 740, and a plurality of photos included in the ‘travel’ photo group are classified into a sub-photo group corresponding to a travel place name 710 and a sub-photo group corresponding to a travel place name 720.

According to an embodiment of the present invention, it is possible to maximize user convenience by classifying a plurality of photos according to both photographing location information and photographing time information of the photos.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of classifying photos, comprising:
classifying a plurality of photos into one or more photo groups according to photographing locations at which corresponding photos are respectively taken; and
performing a photo classifying operation for at least one photo group among the one or more photo groups according to photographing times at which photos included in the photo group are respectively taken.

2. The method of claim 1, wherein the classifying of the plurality of photos into one or more photo groups according to the corresponding photographing locations comprises:
creating a grid map having a plurality of cells and mapping to respective cells a quantity of iterations of a photographing operation which have been performed at a location corresponding to the respective cells and user stay time information indicating how long a user has stayed at the location corresponding to the respective cells, wherein each of the respective cells corresponds to one or more pieces of location information;
choosing one of the respective cells as a first reference cell;
classifying the first reference cell into a first cell group if a quantity of cells which are located within a first predetermined distance of the first reference cell, and correspond to longer user stay times than a first predetermined time, exceeds a first predetermined quantity; and
classifying into a first photo group a plurality of photos photographed at locations corresponding to cells that are classified into the first cell group.

3. The method of claim 2, further comprising:
classifying into a candidate cell group remaining cells of the grid map which do not belong to the first cell group and which correspond to photographing operation iteration quantities not smaller than a value of 1;
choosing one of the cells included in the candidate cell group as a second reference cell;
classifying the current second reference cell into a second cell group if a quantity of cells which are located within a second predetermined distance of the current second reference cell exceeds a second predetermined quantity; and
classifying into a second photo group a plurality of photos corresponding to cells included in the second cell group.

4. The method of claim 3, further comprising:
searching for a name of a place corresponding to photographing location information of the photos included in the second photo group; and
mapping the detected place name to the second photo group.

5. The method of claim 3, wherein the performing of the photo classifying operation for at least one photo group among the one or more photo groups according to photographing times comprises:
sequentially arranging the photos included in the first photo group in order of photographing times;
choosing one of the sequentially arranged photos as a reference photo; and
setting a photo group boundary between the reference photo and a next photo after the reference photo if a time interval between the reference photo and the next photo is larger than a sum of a predetermined value and an average of time intervals among a predefined number of photos ahead of or behind the reference photo.

6. The method of claim 5, wherein the predetermined value is determined based on photographing times of the photos included in the second photo group.

7. The method of claim 3 further comprising:
classifying the current second reference cell into a third cell group if a quantity of cells which are included in the candidate cell group and are located within the second predetermined distance of the current second reference cell is not greater than the second predetermined quantity; and
classifying into a third photo group a plurality of photos corresponding to cells included in the third cell group.

8. A system for classifying photos, comprising:
a location-based classification module to classify a plurality of photos into one or more photo groups according to corresponding photographing locations at which the plurality of photos are respectively taken; and
a time-based classification module to choose at least one of the photo groups and classify a plurality of photos included in the chosen photo group into one or more sub-photo groups according to photographing times at which the photos included in the chosen photo group are respectively taken.

9. The system of claim 8, further comprising a storage module to store the plurality of photos.

10. The system of claim 8, further comprising an additional information management module to create a grid map having a plurality of cells and to map to respective cells the quantity of iterations of a photographing operation which have been performed at a location corresponding to the respective cells and user stay time information indicating how long a user has stayed at the location corresponding to the respective cells, wherein each of the cells corresponds to one or more pieces of location information,
wherein the location-based classification module chooses one of the respective cells as a current first reference cell, classifies the current first reference cell into a first cell group if a quantity of cells which are located within a first predetermined distance of the current first reference cell, and correspond to longer user stay times than a first predetermined time, exceeds a first predetermined quantity, and classifies into a first photo group a plurality of photos corresponding to cells that are classified into the first cell group.

11. The system of claim 10, wherein the location-based classification module classifies into a candidate cell group remaining cells of the grid map which do not belong to the first cell group and which correspond to photographing operation iteration quantities not smaller than a value of 1, chooses one of the cells included in the candidate cell group as a second reference cell, classifies the current second reference cell into a second cell group if a quantity of cells which are located within a second predetermined distance of the current second reference cell exceeds a second predetermined quantity, and classifies into a second photo group a plurality of photos corresponding to cells included in the second cell group.

12. The system of claim 11 further comprising a group name mapping module to search for a name of a place corresponding to photographing location information of the photos included in the second photo group, and to map the detected place name to the second photo group.

13. The system of claim 11, wherein the time-based classification module sequentially arranges the photos included in the first photo group in order of photographing times, chooses one of the sequentially arranged photos as a reference photo, and sets a photo group boundary between the reference photo and a next photo after the reference photo if a time interval between the reference photo and the next photo is larger than a sum of a predetermined value and an average of time intervals among a predefined number of photos ahead of or behind the reference photo.

14. The system of claim 13, wherein the predetermined value is determined based on photographing times of the photos included in the second photo group.

15. The system of claim 11, wherein the location-based classification module classifies the current second reference cell into a third cell group if a quantity of cells which are included in the candidate cell group and are located within the second predetermined distance of the current second reference cell is not greater than the second predetermined quantity, and classifies into a third photo group a plurality of photos corresponding to cells included in the third cell group.

16. At least one medium comprising computer readable code to implement the method of claim 1.

17. At least one medium comprising computer readable code to implement the method of claim 2.
